(19) United States
(12) Patent Application Publication
(10) Pub. No.: US 2016/0172682 A1
(43) Pub. Date: Jun. 16, 2016

(54) METHOD FOR PRODUCING AN ELECTRODE FOR A LITHIUM-ION BATTERY

(71) Applicant: Commissariat A L'Energie Atomique Et Aux Energies Alternatives, Paris (FR)

(72) Inventors: Nelly MARTIN, Miribel Les Echelles (FR); Séverine JOUANNEAU-SI LARBI, Sillans (FR); Julie MOUCHETAN, Grenoble (FR)

(21) Appl. No.: 15/045,627

(22) Filed: Feb. 17, 2016

Related U.S. Application Data
(63) Continuation of application No. PCT/FR2014/052182, filed on Sep. 4, 2014.

(30) Foreign Application Priority Data
Sep. 27, 2013 (FR) 13.59317

(51) Int. Cl. H01M 4/62; H01M 4/04; H01M 4/505; H01M 4/1391; H01M 4/131; H01M 4/525

(52) U.S. Cl. CPC H01M 4/628; H01M 4/131; H01M 4/525; H01M 4/505; H01M 4/1391; H01M 4/0404; H01M 2004/028

(57) ABSTRACT

A method of manufacturing a secondary battery electrode including the steps of: depositing an ink including at least one active electrode material, on a substrate; drying the ink; depositing a protection layer on the previously dried ink; and calendering the electrode thus formed.

### DOMAIN OF THE INVENTION

The invention relates to an electrode manufacturing method. This method particularly comprises calendering an electrode having its active material covered with a protection layer.

The field of use of the present invention particularly relates to the electric energy storage, particularly electrochemical lithium batteries or accumulators.

### BACKGROUND

In electric energy storage, two main types of batteries are currently used: primary batteries and secondary batteries. While the first ones operate according to an irreversible reaction between different chemical species, the second ones are rechargeable batteries.

Generally, a battery comprises a cell core formed of two electrodes having an electrolyte interposed there between. This electrolyte is generally supported by an electrode separator.

As an example, a secondary battery of lithium-ion type may comprise a cell core comprising:
a positive electrode (cathode) made of at least one material for inserting the lithium cation;
an electrode separator;
a negative electrode (anode).

Each electrode is associated with a current collector.

The nature of the electrode materials, and particularly that of the cathode, enables to adjust the average potential at which a secondary battery operates, and also its theoretical specific capacity.

For this purpose, a LMNO (lithium-manganese-nickel) spinel material such as LiMn_{1.5}Ni_{0.5}O₄ is particularly advantageous due to its potential, 4.7 V vs. Li, and to its theoretical specific capacity of approximately 147 mAh g⁻¹.

However, secondary reactions between the cathode and the electrolyte may alter the properties of such electrochemical systems.

Such reactions may cause a significant self-discharge but also a significant degassing during the cycling.

Further, products originating from the decomposition of the electrolyte may also damage the electrode surface area. This is particularly true when hydrofluoric acid is formed.

On the other hand, the forming of a passivation layer, at the interface between the cathode and the electrolyte, may also result from the degradation of the electrolyte. This phenomenon is better known as CEI, for “Cathode Electrolyte Interface”.

Various approaches have been tried to overcome this issue.

For example, it has been provided to protect the cathode by depositing an insulating metal or phosphate layer (ZnO, ZrO₂, AlPO₄, Li₃PO₄). This method results in decreasing the capacity loss of the accumulator, and in improving the electrode lifetime.

The protection then plays the role of:
preventing secondary reactions between the cathode and the electrolyte,
trapping unwanted species resulting from the degradation of the electrolyte,
suppressing the dissolution of transition metals present in the active material of the cathode.

However, this type of protection layer is not fully satisfactory due, in particular, to the absence of a method enabling to deposit a protection layer over the entire surface of active material, while maintaining the high density properties inherent to the active material of the cathode.

Prior art comprises other variations, particularly a coating of the electrode by means of a protection layer made of an electronically conducting material, such as FePO₄, carbon, or metal oxides.

The deposition of better ion conductors, such as LIPON (lithium phosphate oxynitride) has also been studied. In this case, the deposition is generally performed by PVD (physical vapor deposition).

U.S. Pat. No. 6,365,299 especially describes a method comprising:
depositing an electrode ink on a substrate;
drying this ink;
calendering the dried ink;
depositing a protection layer on the dried and calendered ink;
calendering the protection layer.

Although they are relatively satisfactory in terms of electrode protection, such methods however cause a loss of power density due to the shallowness of the deposition, and this, when it is performed by CVD or by ALD.

The Applicant has developed a method enabling to solve this technical problem relative to the loss of power density, by introducing a calendering step during the forming of the protection layer.

### SUMMARY OF THE INVENTION

The present invention relates to a method of manufacturing an electrode for a secondary battery. This electrode comprises a layer protecting it against any secondary reaction between the electrode and the electrolyte, and against chemical species originating from the possible degradation of the electrolyte. The protection layer further enables to suppress the dissolution of transition metals present in the active electrode material. Finally, the protection layer is made of an electronically conducting material, which enables to maintain the electronic conduction properties.

More specifically, the object of the present invention is a method of forming an electrode for a secondary battery, comprising the steps of:
depositing an ink comprising at least one active electrode material, on a substrate;
drying the ink;
depositing a protection layer on the previously dried ink; calendering the electrode thus formed.

In other words, conversely to prior art, the protection layer is deposited before the calendering of the electrode, to be able to benefit from the porosity of the dried ink to introduce the protection layer at the surface of the active electrode material across the electrode thickness. The method according to the invention comprises no calendering step between the drying of the ink and the deposition of the protection layer.

The protection layer may be ionically conducting or insulating.

In the case of an insulating layer, the thickness of the protection layer is advantageously low, typically lower than 100 nm, and more advantageously still lower than 5 nm.

In the case of a deposition by ALD, the thickness of the protection layer is for example in the range from 3 to 15 Angström.

In the case of an ion conductor layer, for example, of LIPON type, the thickness of the protection layer preferably is in the range from 20 nm to 300 nm.

Advantageously, the protection layer is made of metal oxide. It may advantageously be selected from among Al₂O₃, Cr₂O₃, ZrO, ZrO₂, MgO. More advantageously still, it is Al₂O₃.

According to a specific embodiment, the protection layer may be made of metal phosphate, and particularly of a material selected from the group comprising Li₃PO₄, FePO₄, and AlPO₄.

The protection layer may be deposited by deposition techniques within the general knowledge of those skilled in the art. It may preferably a deposition by ALD (“Atomic Layer Deposition”), PVD (“Physical Vapor Deposition”), CVD (“Chemical Vapor Deposition”), MBE (“Molecular Beam Epitaxy”), EBPVD (“Electron Beam Physical Vapor Deposition”), or PLD (“Pulsed Laser Deposition”).

It preferably is an ALD, which has the advantage of being a conformal deposition, covering the electrode with a better uniformity.

Depositions by ALD are generally carried out from a precursor, and particularly a metal oxide.

Thus, when the protection layer is made of LIPON (lithium phosphate oxynitride), it may in particular be obtained by reaction of Li₃PO₄ with nitrogen.

The electrode thickness may vary from 1 micron to 700 microns, usually from 50 to 500 microns.

The percentage by weight of the deposition is advantageously smaller than 10%, preferably smaller than 5%, to keep an acceptable mass density.

The electrode formed by implementation of the method according to the invention advantageously is a lithiated positive electrode (cathode).

The active electrode material advantageously is a positive electrode material. It preferably is a lithium cation insertion material. It may in particular be selected from the group comprising spinel lithium-manganese-nickel oxides (for example: LiMnMO₄, with M=Cr, Fe, Co and/or Ni), cobalt oxides (for example: LiCoO₂), vanadium oxides (for example: LiV₃O₈, V₂O₅), manganese oxides (for example: LiMn₂O₄, LiMnO₂), iron phosphate (for example: LiFePO₄), graphites, silicon, and titanium oxides (for example: TiO₂, Li₄Ti₅O₁₂).

Advantageously, it may be a spinel lithium-manganese-nickel (LMNO) oxide, more advantageously LMNO of formula LiMn₅Ni_{0.5}O₄.

The insertion material forming the positive electrode may be deposited on the substrate by various deposition techniques such as coating, silk-screening, inkjet, or spraying.

For example, an ink, particularly based on LMNO, may be printed or directly spread on the substrate according to techniques within the knowledge of those skilled in the art.

Further, and advantageously, the positive electrode ink is based on a solvent.

Positive electrode inks are preferably aqueous or organic inks comprising a polymer binder of polyacrylic acid or fluoropolymer type.

The electrode ink may also comprise conductive particles, for example, carbon black.

The substrate having the electrode formed thereon is advantageously made of an electronically conductive material.

According to a specific embodiment, the substrate corresponds to the current collector of the electrode. It may in particular be made of copper or of aluminum.

The present invention also relates to the electrode obtained according to the above-described method, as well as to the secondary lithium-ion battery comprising this electrode.

As already indicated, the deposition of the protection layer, (metal oxide, for example) is performed after the drying of the electrode, that is, before the calendering. In other words, and conversely to prior art, the deposition is performed when the electrode has a maximum porosity. Thus, the material of the protection layer (especially metal oxide) penetrates to the heart of the electrode material on deposition thereof. On this regard, techniques of deposition by ALD and CVD are particularly advantageous. Further, the calendering of the electrode after the deposition of the protection layer enables, on the one hand, to increase the covering surface area of the deposited protection layer (metal oxide, for example), and on the other hand to increase the surface area of contact between the active material and the conductive additives, and thus the electronic conduction.

The electrode resulting from this process may in particular be assembled in an electro-chemical cell comprising a negative electrode made of LTO (lithium titanate), of graphite, of silicon, or of metal lithium.

As already indicated, a secondary battery comprises a cell core formed of two electrodes of opposite signs having an electrolyte interposed therebetween.

Of course, in this type of device, the above-described protection layer is in contact with the electrolyte.

The electrolyte may in particular be a mixture of organic solvents, such as carbonates, into which an alkaline metal salt is added. In a lithium-ion battery, the salt may in particular be a lithium salt, for example, LiPF₆ or LiTFSI (lithium bis(trifluoromethanesulfonyl)imide). As far as possible, this mixture is free of traces of water or oxygen.

It will be within the abilities of those skilled in the art to select the adequate electrolyte.

The electrolyte is generally supported by an electrode separator. It may be made of a polymer or microporous composite separator impregnated with organic electrolyte enabling to displace the lithium ion (case of a lithium-ion battery) from the positive electrode to the negative electrode and conversely (case of the charge or the discharge), thus generating the current.

The invention and the resulting advantages will better appear from the following non-limiting drawings and examples, provided as an illustration of the invention.

### BRIEF DESCRIPTION OF THE DRAWINGS

FIG. 1 illustrates a composite electrode of small thickness according to prior art, obtained by deposition of an active material and of carbon black on a current collector and deposition of a protection layer on the surface of the active material and of the carbon black.

FIG. 2a illustrates a composite electrode obtained according to prior art, by deposition of an electrode ink on a current collector and drying, before calendering.

FIG. 2b illustrates a composite electrode obtained according to prior art, by deposition of an electrode ink on a current collector and drying, after calendering.

FIG. 3 illustrates a composite electrode obtained according to prior art, by deposition of an electrode ink on a current collector, drying of the deposit, calendering, and deposition of a protection layer.

FIG. 4a illustrates a specific embodiment of a step of the method according to the invention, where a composite electrode ink is deposited on a current collector, dried, and then covered with a protection layer.

FIG. 4b illustrates a specific embodiment of a step of the method according to the invention where a composite electrode ink, previously dried and covered with a protection layer, is calendered to form an electrode.

### DETAILED DESCRIPTION OF THE INVENTION

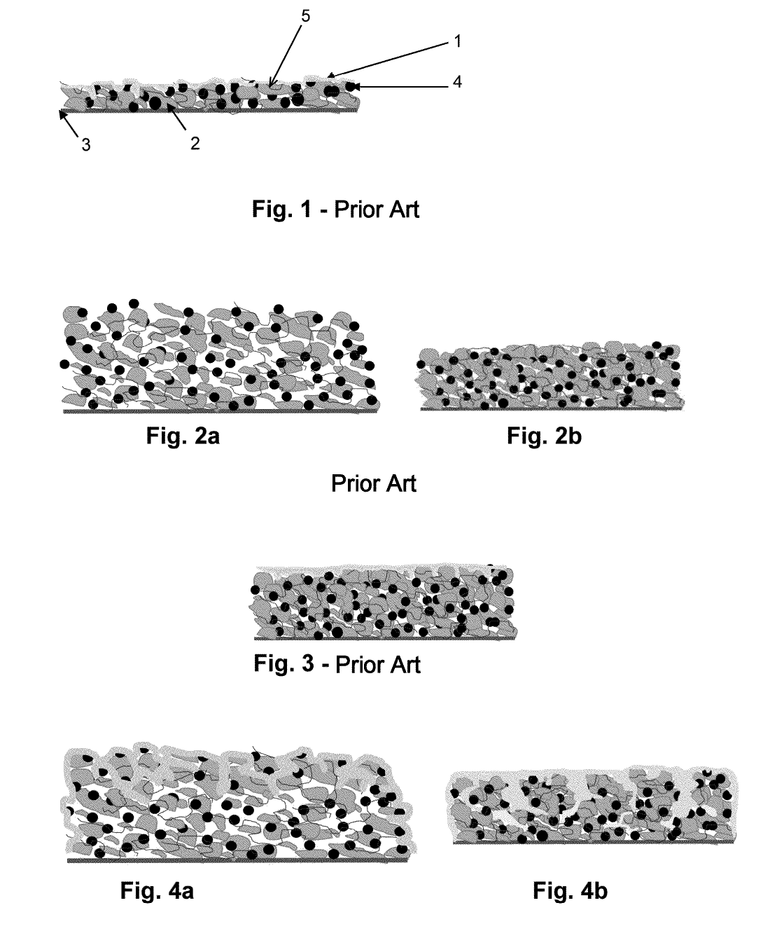

Prior art electrodes are made of the active material (2), of conductive particles (4), and of a binder (5), deposited on the substrate (3), and covered with the protection layer (1) (FIG. 1). In a conventional secondary battery of small thickness and low basic weight (<0.5 mAh/cm²), the grains of active material (2) remain in contact with the substrate (3), thus allowing the transport of electrons to the negative electrode via the external circuit when the substrate is electronically conductive.

The increase of the energy density requires an increase of the basic weight, that is, of the electrode thickness, and a decrease of the porosity.

The manufacturing of this type of electrode according to prior art first comprises depositing an ink on a substrate (3). After the drying of the electrode, the porosity rate of the electrode is in the order of 80% due to the evaporation of the ink solvents (FIG. 2a).

At this stage, the contact between the grains of materials and the conductive additives is not sufficient to convey the electrons to the current collector. It is thus necessary to calender the electrode in order to decrease its porosity to obtain a satisfactory electronic percolation (FIG. 2b).

A deposition of protective material on such a calendered electrode is illustrated by FIG. 3. One of the disadvantages of this configuration is that it does not allow the conduction of ions across the entire electrode thickness. A strong electrochemical inactivity can then be observed, thus resulting in a loss of energy density.

In the method according to the invention (FIGS. 4a and 4b), the electrode ink is deposited on the substrate (3) according to conventional deposition techniques. Once dried, the electrode has a maximum porosity. Conversely to prior art methods, this is the time when the protection layer (1) is deposited (FIG. 4a).

Due to the strong porosity of the electrode, the protection layer (1) then penetrates into the electrode. This method is favored by the deposition technique, which advantageously is ALD or CVD.

Once the protection layer has been deposited, the electrode is densified by calendering (FIG. 4b).

1. A method of manufacturing a secondary battery electrode comprising the steps of:
depositing an ink comprising at least one active electrode material, on a substrate;
drying the ink;
depositing a protection layer on the previously dried ink; and calendering the electrode thus formed.

2. The secondary battery electrode manufacturing method of claim 1, wherein the protection layer is made of metal oxide or of metal phosphate.

3. The secondary battery electrode manufacturing method of claim 1, wherein the protection layer is made of a material selected from the group comprising Al₂O₃, Cr₂O₃, ZrO, ZrO₂, MgO, Li₃PO₄, FePO₄, AlPO₄, and LIPON.

4. The secondary battery electrode manufacturing method of claim 1, wherein the protection layer is deposited by a deposition technique selected from the group comprising ALD, PVD, CVD, MBE, EBPVD, and PLD.

5. The secondary battery electrode manufacturing method of claim 1, wherein the substrate is made of an electronically conducting material.

6. The secondary battery electrode manufacturing method of claim 1, wherein the active material is a positive electrode material.

7. The secondary battery electrode manufacturing method of claim 6, wherein the active electrode material is a lithium cation insertion material selected from the group comprising spinel lithium-manganese-nickel oxides, cobalt oxides, vanadium oxides, manganese oxides, iron phosphate, graphites, silicon, and titanium oxides.

8. The secondary battery electrode manufacturing method of claim 6, wherein the active material is LiMn_{1.5}Ni_{0.5}O₄.

9. A battery electrode obtained according to the method of claim 1.

10. A secondary lithium-ion battery comprising the electrode of claim 9.
